(19) United States
(12) Patent Application Publication
(10) Pub. No.: US 2005/0263649 A1
(43) Pub. Date: Dec. 1, 2005

(54) AUTONOMOUS VEHICLE DOCKING SYSTEM

(75) Inventors: Greg Alan Ritter, Hamburg, MI (US); Anthony Beckman Hays, Howell, MI (US); Peter Tchoryk JR., Ann Arbor, MI (US); Jane Camile Pavlich, Ann Arbor, MI (US); Gregory Joseph Wassick, Petersburg, MI (US)

Correspondence Address: RAGGIO & DINNIN, P.C., 2701 CAMBRIDGE COURT, STE. 410, AUBURN HILLS, MI, 48326, US

(73) Assignee: MICHIGAN AEROSPACE CORPORATION, Ann Arbor, MI (US)

(21) Appl. No.: 10/907,091

(22) Filed: Mar. 18, 2005

Related U.S. Application Data
(60) Provisional application No. 60/554,763, filed on Mar. 18, 2004.

(51) Int. Cl. B64G 1/64

(52) U.S. Cl. 244/172.4

(57) ABSTRACT

An autonomous vehicle docking system restrains six degrees of freedom through the use of a plurality of latches having differing bearing surface geometry which each constrain a generally spherical post end, and with a soft-dock cable system to initiate the capture sequence and provide for positive disengagement by a capture vehicle.

The instant application claims the benefit of prior U.S. Provisional Application Ser. No. 60/554,763 filed on Mar. 18, 2004, which is incorporated herein in its entirety by reference.

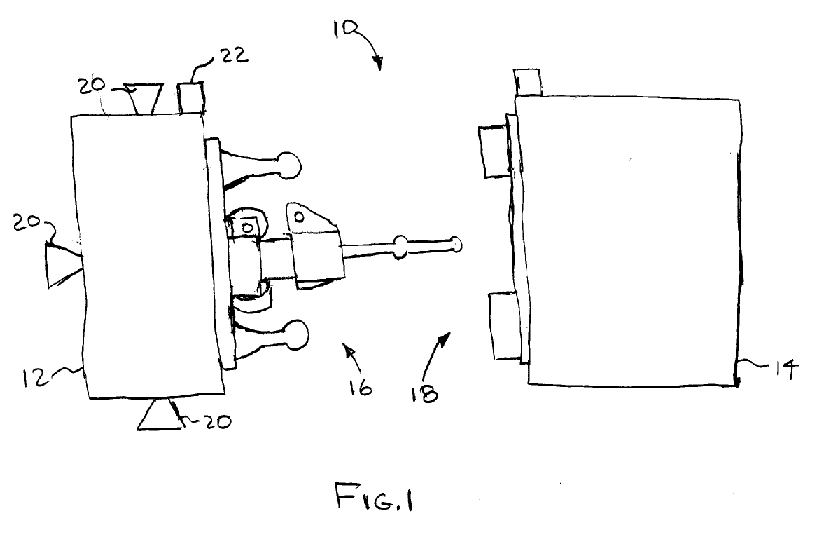

FIG. 1 illustrates an approach of a chase vehicle to a target vehicle prior to docking using an autonomous vehicle docking system.

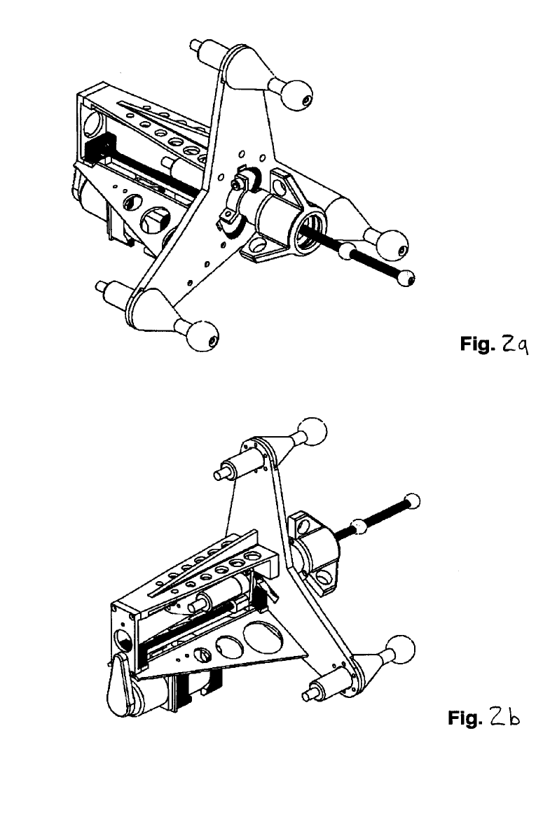

FIG. 2a illustrates first isometric view of a first docking mechanism, from the perspective of the docking side thereof.

FIG. 2b illustrates second isometric view of the first docking mechanism, from the perspective of the vehicle side thereof.

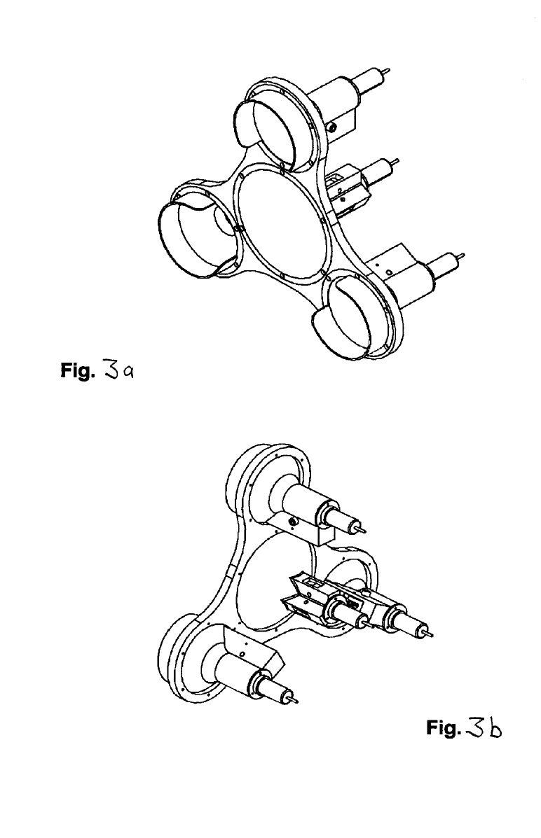

FIG. 3a illustrates first isometric view of a second docking mechanism, from the perspective of the docking side thereof.

FIG. 3b illustrates second isometric view of the second docking mechanism, from the perspective of the vehicle side thereof.

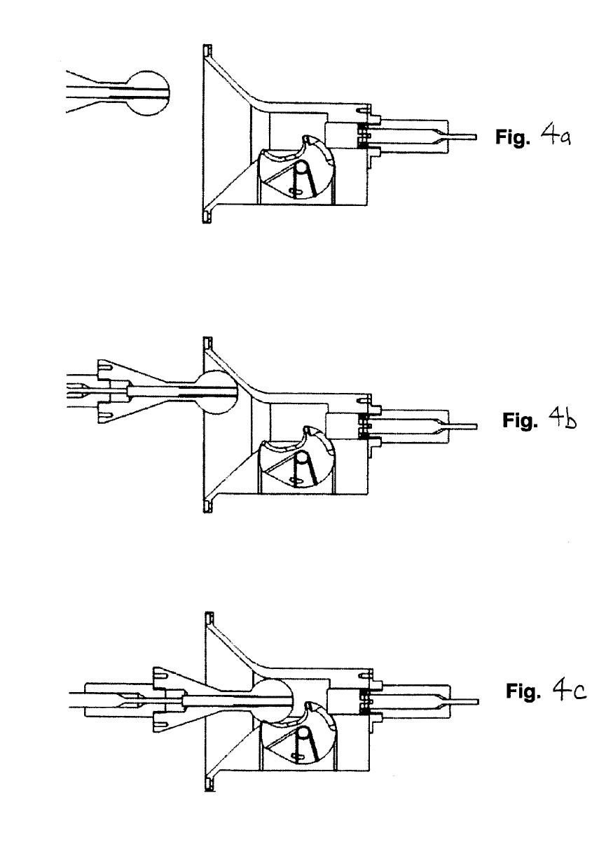

FIGS. 4a-4c illustrate an automatic latch mechanism and the entry of an auto-alignment load-bearing post thereinto during docking.

FIGS. 5a and 5b a release of an automatic latch mechanism during separation from docking.

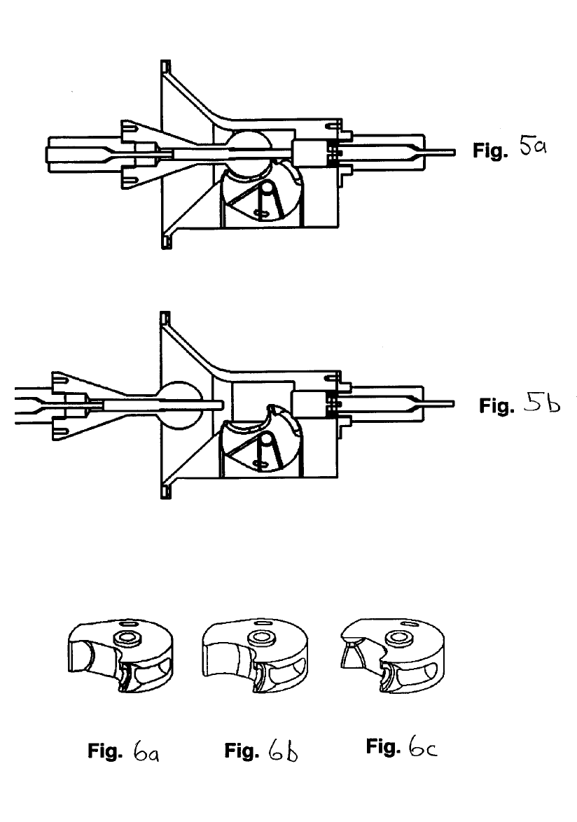

FIGS. 6a-6c illustrate various latches of the associated automatic latch mechanisms.

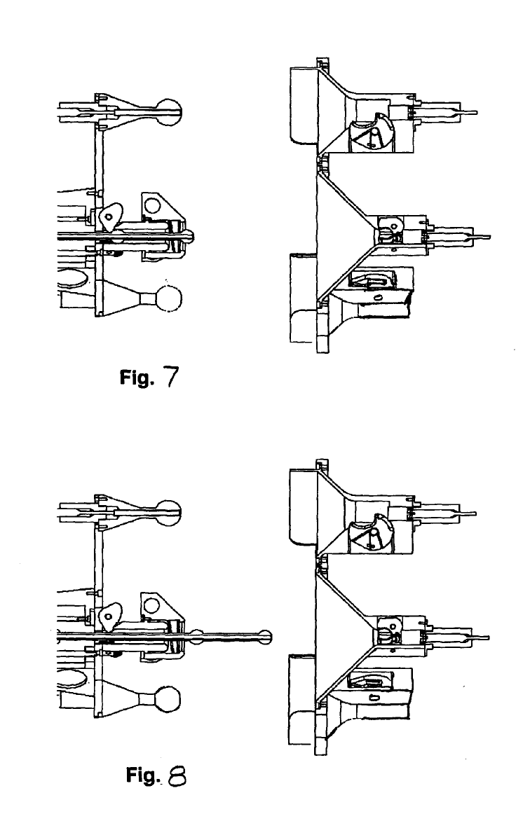

FIG. 7 illustrates approach and proximity operations of an autonomous vehicle docking system.

FIG. 8 illustrates a soft-dock cable extension operation of an autonomous vehicle docking system.

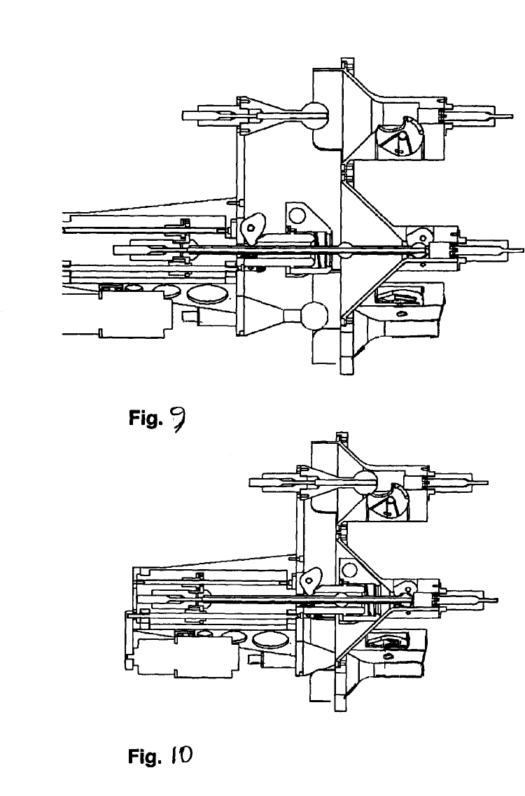

FIG. 9 illustrates a soft-dock capture operation of an autonomous vehicle docking system.

FIG. 10 illustrates cable retraction and hard dock operations of an autonomous vehicle docking system.

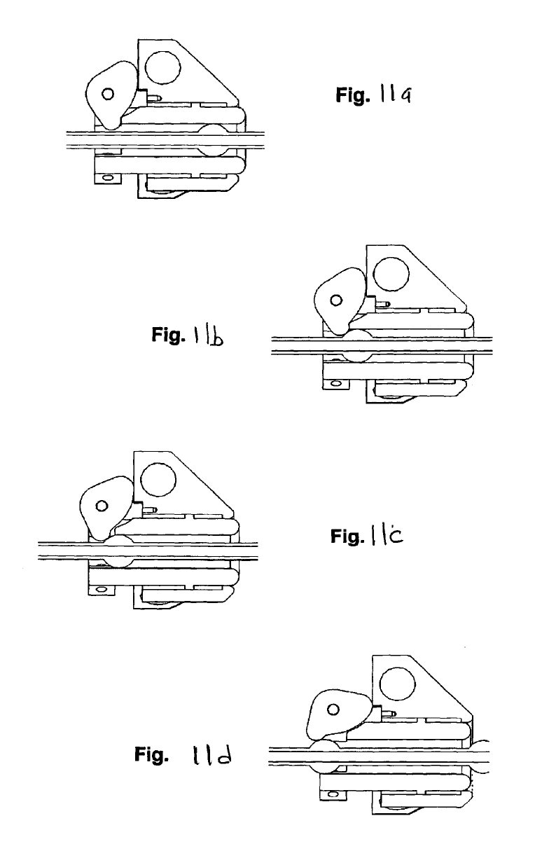

FIGS. 11a-11d illustrate a structure and operation of a cam-operated preload system.

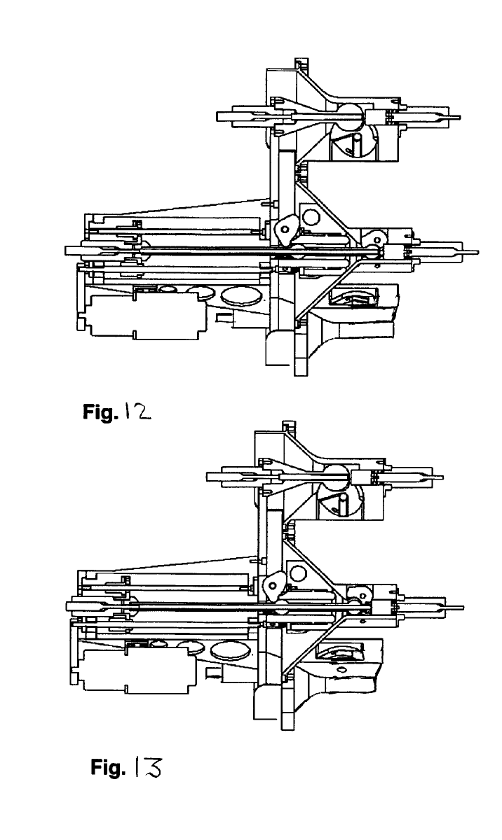

FIG. 12 illustrates a post-engagement rigidization operation of an autonomous vehicle docking system.

FIG. 13 illustrates a soft-dock cable release operation of an autonomous vehicle docking system.

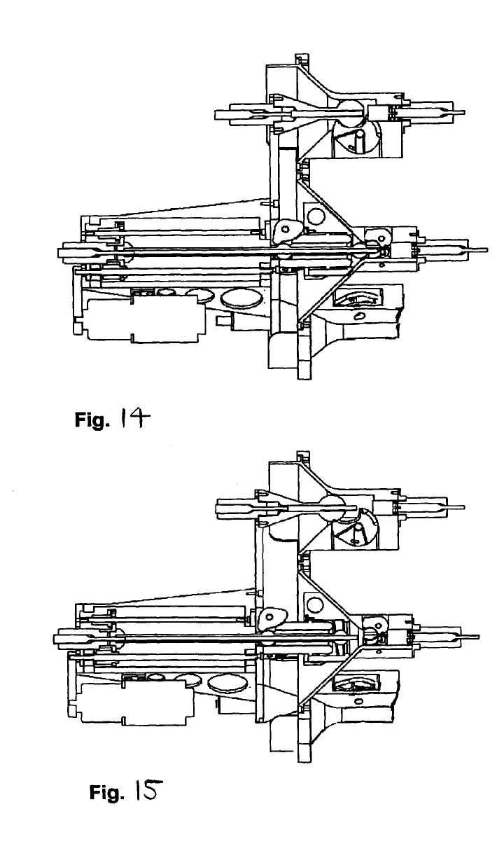

FIG. 14 illustrates cable retraction and preload operations of an autonomous vehicle docking system.

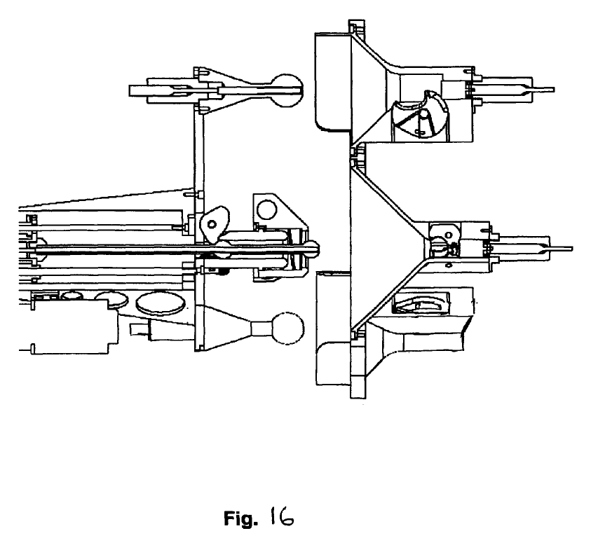

FIG. 15 illustrates post latch-release and un-dock operations of an autonomous vehicle docking system.

FIG. 16 illustrates a vehicle separation with positive push-off force operation of an autonomous vehicle docking system.

### DESCRIPTION OF EMBODIMENT(S)

Referring to FIG. 1, and autonomous vehicle docking system 10 is provided for docking a chase vehicle 12 to a target vehicle 14, wherein, for example, the chase vehicle 12 is adapted to perform the capture or servicing operations, and, for example, the target vehicle 14 is adapted to be captured or serviced. The autonomous vehicle docking system 10 comprises a first docking mechanism 16, for example, attached to or part of the chase vehicle 12, and a second docking mechanism 18, for example, attached to or part of the target vehicle 14, wherein the first 16 and second 18 docking mechanisms are adapted to mate with one another so as to provide for docking the chase vehicle 12 to the target vehicle 14. For brevity, the first docking mechanism 16 will be referred to herein as the chaser 16, and the second docking mechanism 18 will be referred to herein as the target 18. Notwithstanding this nomenclature however, it should be understood that, alternatively, the first docking mechanism 16 could be attached to or part of the target vehicle 14 and the second docking mechanism 18 could be attached to or part of the chase vehicle 12. The chase 12 and target 14 vehicles are not limited to a particular type of vehicle, and, for example, could be underwater or surface aquatic vehicles, ground-based vehicles, spacecraft, or aircraft. The chase vehicle 12 is, for example, provided with a plurality of thrusters 20 which provide for maneuvering the chase vehicle 12 relative to the target vehicle 14 so as to provide for initiating a docking operation therebetween, under the guidance of an autonomous guidance, navigation and control system 22. The autonomous vehicle docking system 10 is adapted to provide for auto-alignment of the chaser 16 with the target 18, which is defined as a process of automatically aligning the chaser 16 with the target 18 during a docking operation without a separate active components or a separate alignment stage of the docking sequence.

Referring to FIGS. 2a and 2b, a first support structure 24 of the chaser 16 supports three auto-alignment load-bearing posts 26 distributed about a central docking axis 28 and distal with respect thereto. A hard-dock probe head 30 is adapted to slide with respect to a central hollow stub shaft 32 extending from the first support structure 24, and a soft-dock cable 34 is adapted to slide within the central hollow stub shaft 32 and extent therefrom responsive to a soft-dock cable retraction system 36. A plurality of cams 38 of a pre-load cam mechanism 40 are supported on associated pivots 42 from the first support structure 24 are adapted to operative between the soft-dock cable 34, and the hard-dock probe head 30 responsive to an actuation by the soft-dock cable retraction system 36.

The auto-alignment load-bearing posts 26 comprise rigid posts, e.g. constructed of metal, adapted with spherical ends 44. A hole 46 drilled through the center of each auto-alignment load-bearing post 26 houses an associated push-rod 48, which is actuated by an associated release solenoid 50.

The hard-dock probe head 30 is biased away from the first support structure 24 along the central hollow stub shaft 32 by a spring 52 operative therebetween, so as to provide for compliance between the chaser 16 and target 18 so as to provide for absorbing docking-induced forces imparted by a collision of associated parts during a docking operation. The spring 52 also provides for imparting a small push-off force during an un-docking operation to aid in separating the chase 12 and target 14 vehicles.

Referring to FIGS. 3a and 3b, a second support structure 54 of the target 16 supports a main capture receptacle 56 associated with the hard-dock probe head 30 and soft-dock cable 34, and three auto-alignment capture receptacles 58 associated with the corresponding three auto-alignment load-bearing posts 26. The main capture receptacle 56 provides for guiding and capturing the soft-dock cable 34 during a soft-dock operation, and for aligning with the hard-dock probe head 30 during a hard-dock operation. The three auto-alignment capture receptacles 58 provide for aligning and capturing the auto-alignment load-bearing posts 26 during a hard-dock operation. A soft-dock operation provides for the capture of the target vehicle 14 by the chase vehicle 12 by a method that imparts little or no force on the target vehicle 14. A hard-dock operation provides for the capture of the target vehicle 14 by the chase vehicle 12 in a manner that nominally involves a collision between fixed parts of the chase 12 and target 14 vehicles, which imparts some force to the target vehicle 14.

The soft-dock cable 34 comprises a multi-component flexible member with an end effector 60, e.g. a spherical end 60′, e.g. constructed of metal, is mounted for the target receptacle to capture, and which is extended from the chaser to engage the target vehicle's main receptacle during a soft-dock operation.

The hard-dock probe head 30 comprises a conical section, e.g. constructed of metal, that makes contact with the main capture receptacle 56 during the hard-dock phase of the docking operation.

The main capture receptacle 56 comprises a main target cone 62 which serves as a centrally located capture target for the initial contact with the end effector 60 on the soft-dock cable 34. The main target cone 62 can be made as wide or as narrow as necessary to capture the end effector 60 as it is extended outward from the chaser 16. The main capture receptacle 56 also incorporates a three-pronged trigger latch mechanism 64 to capture the end effector 60 as the end effector 60 depresses the associated latches 66 during a soft-dock phase of the docking operation After a successful soft-dock, as the soft-dock cable 34 is retracted by the soft-dock cable retraction system 36, the hard-dock probe head 30 of the chaser 16 then engages this main target cone 62 so as provide for a rough alignment of the chase 12 and target 14 vehicles so as to prevent large-angle pitch and yaw skewing.

Referring to FIGS. 4a-4c, each auto-alignment capture receptacle 58 cooperates with an associated conical guide ramp 68 which provides for accommodating roll and positional misalignments during a docking operation. The conical guide ramps 68 also provide for directly docking the chase 12 and target 14 vehicles with a hard-dock operation without first undergoing a soft-dock operation, for example, in the event of a failure that would otherwise preclude a soft-dock operation, e.g. a failure of the soft-dock cable 34, the soft-dock cable retraction system 36, or the trigger latch mechanism 64 of the main capture receptacle 56. For example, with the soft-dock cable 34 in a stowed position, the auto-alignment load-bearing posts 26 can guided into the associated auto-alignment capture receptacles 58 using the thrusters 20 of the chase vehicle 12 and guided by the associated autonomous guidance, navigation and control system 22 and associated attitude control systems, if sufficiently accurate.

An anti-roll shield 70, e.g. a metal collar, is attached to the outside surface 72 of each conical guide ramp 68 so as to provide a physical boundary for the auto-alignment load-bearing posts 26 during docking, so as to prevent the chaser 16 from rolling with respect to the target 14 beyond the capture boundaries of the autonomous vehicle docking system 10.

The auto-alignment capture receptacles 58 provide for a fine control of alignment of the auto-alignment load-bearing posts 26 after the auto-alignment load-bearing posts 26 are guided thereinto by the associated conical guide ramps 68. Each auto-alignment capture receptacle 58 incorporates an associated latching capture mechanism 74 which is initially in an un-latched state, and which becomes latched when the auto-alignment load-bearing posts 26 depress the associated latches 76 thereof.

In accordance with the autonomous vehicle docking system 10, an automatic latch mechanism (ALM) is defined as the capture mechanism used by the target vehicle to capture the soft-dock cable and the auto-alignment posts on the chaser vehicle. When the cable end or the auto-alignment post for a given receptacle depresses the bottom of the latch, the latch body rotates about a pivot to close over the object. When in the closed position, a detent in the bottom of the latch body lines up with a spring-loaded plunger, which slides forward into the detent. This effectively prevents the latch from rotating back and firmly locks the capture device.

The autonomous vehicle docking system 10 principle of operation can be applied to many different types of latches, and any method of automatically clasping the spherical ball on the end of a cable or post, with the ability to release said sphere from either side of the interface, are part of the intentions claimed for this design. The automatic latch mechanism (ALM), which is used to capture the soft-dock cable and to secure the auto-alignment posts once engaged. The mechanism consists of a latch or a set of latches that are spring-loaded to remain open at the bottom of a target receptacle like the jaws of a bear trap.

Referring to FIGS. 5a and 5b, to release the latch, either the piston can be retracted from the receptacle side by a solenoid, or a solenoid on the probe side can extend a push-rod to depress the locking piston. This allows the latch to rotate freely and release the captured probe. Though, nominally, the probe side push-rod is used to release the latch, having a second solenoid on the target mechanism allows the target side to break the interface in the case of an emergency. Additionally, since solenoids are used to actuate these mechanisms, multiple solenoid bodies can be stacked on a single plunger to allow for redundant backups on one or both sides of the interface.

In accordance with the autonomous vehicle docking system 10, degrees of freedom (DOF) are defined as the number of Cartesian directions in which a point can freely move. There are three (3) translational degrees of freedom along the x, y, and z Cartesian coordinate directions. There are also three (3) rotational degrees of freedom about the same axes. Combined, a given point has a possible total of six (6) degrees of freedom.

Referring to FIGS. 6a-6c, the parts illustrated are from one of the outlying post latches. The latches on these devices are machined to provide a kinematic mount as the posts are pulled against them during rigidization Each of these three latches is slightly different to provide the kinematic alignment system that ensures exact, repeatable positioning from docking to docking. The first latch is machined as a spherical socket, which just fits the spherical auto-alignment probe it corresponds to. The spherical socket constrains movement in three dimensions, but not rotation. The second latch is machined with a V-groove contact on its spherical auto-alignment probe, which constrains two rotation degrees of freedom about the center of the first latch. The final latch is machined with a simple planar contact on its alignment probe, which eliminates the final degree of freedom in the interface. All three kinematic surfaces lock in place behind the spheres on the ends of their respective posts. By pulling the alignment post spheres back against these three kinematic surfaces, known as generating a pre-load force, exactly 6 degrees of freedom are eliminated, with no over-constraint. This also provides a solid, well-defined load path for the interface.

Referring to FIG. 7, the AVDS mechanism is on approach, with the mechanism interface halves moving into position, controlled by the on-board autonomous guidance, navigation and control system. Note that the cable is in a stowed position and that the latching receptacles on the target side of the interface are all in the “open” configuration. At this stage, all mechanisms are relaxed and there is no power required to maintain either side of the interface.

Referring to FIG. 8, once the mechanisms have been positioned by the guidance systems of the vehicles, the soft-dock cable is extended out from the chaser mechanism. This is accomplished by driving the cable shuttle, to which the cable is attached, outward on a linear actuator. The cable extension distance can be shortened so that the load-bearing posts on the outward edges of the chaser interface enter the outer envelope of their respective receptacles at this stage to provide a measure of roll limitation.

Referring to FIG. 9, the soft-dock cable is guided into the cable receptacle on the target mechanism as the vehicles close their separation distance. As soon as the spherical cable end depresses the bottom of the cable latches, they rotate with the continued cable advancement, trapping the sphere in the receptacle. As the latches reach the “closed” position, the spring-loaded locking piston behind the latches snaps forward into the latch detents, locking them in place. The soft-dock cable is now captured, and the interface is considered “soft-docked”. The vehicles are tethered and cannot drift apart. At this point, the ends of the auto-alignment probes are positioned just inside the envelope defined by the anti-roll shields of the auto-alignment targets. This limits the interface rotation about the docking axis.

Once soft-dock has been achieved, the linear actuator is engaged in reverse, retracting the cable. This brings the interface mechanisms together until the spring-loaded probe head mounted on the chaser mechanism comes into contact with the target's cable guide cone. The head's spring provides some cushioning of the impact forces felt during this first hard contact, and prevents translation of one vehicle relative to the other normal to the docking axis.

Referring to FIG. 10, the soft-dock cable latch operates on an identical principle, except that instead of a single latch, there are three spherical latches arranged at 120-degrees about the docking axis. These latches are not required to perform exact alignment, only to capture the cable during soft-dock and retraction. As can be seen from FIG. 10, the load-bearing posts also begin to seat in their respective receptacles at this stage.

Referring to FIGS. 11a-11d, an interface preload system provides for applying a relatively stiff tension to the coupled components so as to resist flexure at the interface. This is provided for by a cam system mounted behind the hard dock head structure of the chaser mechanism. Because the load-bearing posts are captured loosely by their target receptacles during the rigidization phase of the docking, a stiff pre-load force can be generated by simply pulling back on the posts with respect to the target structure. This is accomplished by pushing outward on the hard dock probe head, which is at that point in contact with the cable guide cone on the target structure. This pulls the spherical post ends back against the kinematic latches and provides a stiff, repeatable alignment.

The probe head is driven out by the cam system, which rotates about a fulcrum point behind the head. After the post latches have been engaged, the soft-dock cable is released and retracted into the chaser mechanism. A spherical stop along the cable depresses one side of the rocking cam as it travels past. This causes the cam to rotate up against the hard dock probe head and lock in place once the line of contact with the cam surface is in-line with the cam's pivot. At this point, the reaction force's line of action passes through the pivot and the cable position is sufficient to prevent the cam from rotating back and loosening the interface. The resulting tension created serves to rigidly lock the head position.

Referring to FIG. 12, the continued retraction of the soft-dock cable compressed the probe head further onto its spring until the head is close to contact with the pre-load cams located around the head's mounting post. At this stage, the load-bearing posts are also fully seated in their receptacles, depressing the latches there and engaging the locking pistons, identical to the manner in which the cable receptacle latches were engaged. The load-bearing posts, as they seat in the receptacles, provide roll alignment for the interface. At this point, the mechanism interface is physically coupled, though the interface still has some tolerance for movement allowed.

Referring to FIG. 13, once the load-bearing posts have been engaged, the cable receptacle latches are released. This is accomplished by extending a push-rod from the center of the soft-dock cable with a solenoid mounted behind the cable shuttle. The push-rod depresses the locking piston, allowing the latches to rotate freely, and the cable is retracted slightly to clear the latches in the receptacle. This retraction also brings a second sphere (the pre-load activation stop) mounted on the cable into contact with the pre-load latch surfaces inside the center post body. At this stage, as in the previous stage, the interface has some “slop” allowance, since the tolerances of the latches is sufficient to allow the load-bearing posts to move slightly and rotate about three axes.

Referring to FIG. 14, the cable is retracted a slight distance further to its end-of-travel. This causes the pre-load activation stop to press backward against the pre-load cams, rotating them through approximately 60-degrees of movement. The leverage this generates is manifested as the cams press forward on the probe head, effectively pushing outward on the center of the interface. This causes the load-bearing posts to pull tight against their respective latches. The spherical, v-grooved, and planar latch surface shapes provide a kinematic mount, which exactly eliminates 6 degrees of freedom and provides absolute, repeatable alignment.

Once the pre-load cams have rotated a sufficient amount, the load-bearing surface of the cam in contact with the probe head is directly in-line with the cam's pivot, effectively locking the cam in position and placing all the interface surfaces of the mechanism under tension. This provides the most rigid interface possible and is limited only by the material efficiency.

It is this point at which the servicing and fluid transfer operations would take place, though the architecture for these interfaces is not part of the central docking mechanism.

Referring to FIG. 15, once all servicing operations have been completed and the vehicles are ready to undock, a push-rod located in each load-bearing post is extended from the chaser mechanism to depress the locking piston on the corresponding target receptacle. This allows the load-bearing post latches in the target mechanism to rotate freely, releasing the interface. The hard-dock probe head spring, which is still under compression, decompresses, pushing the probe head outward. This push against the target cable guide cone provides a positive separation force that will move the vehicles apart until they reach a separation distance sufficient that attitude control systems on the two vehicles can be safely reactivated.

Referring to FIG. 16, The autonomous vehicle docking system provides for improved reliability from the fact that the remote-passive latching interfaces on the target mechanism can be actuated from either side of the interface. This provides for an emergency release feature previously not incorporated into the earlier docking mechanism designs. This also means that if one mechanism fails during an undocking attempt, the other vehicle's release mechanism can be used as a backup.

Another important distinction with this design is that docking could occur even without a soft-dock stage. Should the soft-dock cable receptacle fail to capture the cable end effectively, the system could be used in a gentle hard-dock-only berthing attempt, foregoing the cable stages of the docking operation and instead making first contact with the hard dock probe head. The probe head is designed to soften the impact forces, and will help to minimize force imparted during such contact. Driving the interface halves together with the vehicle thrusters, then, would cause the load-bearing posts to engage independent of the center cone, and the docking would then be completed normally.

Similarly, in the event of a post latch failure, the soft-dock cable could be used as the sole connection, allowing the posts to simply rest passively in their receptacles. Though this would not provide as much stability or rigidity at the interface, it is still possible to use this approach to position the target vehicle using the chaser's thrusters, or to possibly engage servicing architectures if their compliance is sufficient to utilize the looser interface.

While specific embodiments have been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A system for docking a chase vehicle to a target vehicle having at least one passive, spring-actuated receptacle, said system comprising:
a selectably extensible member located on said chase vehicle; and
at least one locking pawl located on said chase vehicle for engaging said receptacle.

2. A system for docking a chase vehicle to a target vehicle comprising:
at least one passive, spring-actuated receptacle on one of said chase vehicle or said target vehicle;
at least one locking pawl located on the other of said chase vehicle or said target vehicle for engaging said at least one receptacle; and
disengagement means on each of said chase vehicle and said target vehicle for independently disengaging the docking relationship.

3. A system for docking a chase vehicle to a target vehicle having a plurality of receptacles, comprising:
a first engagement means comprising a selectively extensible flexible member located on the chase vehicle and engageable with one of said receptacles; and
a second engagement means comprising at least one non-extensible member engageable with another of said receptacles.

4. A docking latch comprising a plurality of bearing faces each for engaging a rounded locking pawl, at least two of said bearing faces having different surface selected from the following: a planar surface; a “V” shaped surface, or a curved surface.

5. A docking latch comprising at least three conical receptacles for receiving mating latching members.
